(19) United States
(12) Patent Application Publication
(10) Pub. No.: US 2024/0154104 A1
(43) Pub. Date: May 9, 2024

(54) PATTERNED SILICON ANODE ELECTRODES FOR ALL-SOLID-STATE BATTERY CELLS

(71) Applicant: GM GLOBAL TECHNOLOGY OPERATIONS LLC, Detroit, MI (US)

(72) Inventors: Zhe LI, Shanghai (CN); Xingcheng XIAO, Troy, MI (US); Qili SU, Shanghai (CN); Yong LU, Shanghai (CN); Haijing LIU, Shanghai (CN)

(21) Appl. No.: 18/363,036

(22) Filed: Aug. 1, 2023

(30) Foreign Application Priority Data
Nov. 9, 2022 (CN) 202211400795.6

(51) Int. Cl. H01M 4/38; H01M 10/0525; H01M 10/0562; H01M 10/058

(52) U.S. Cl. CPC H01M 4/386; H01M 10/0525; H01M 10/0562; H01M 10/058; H01M 2300/008

(57) ABSTRACT

A battery cell includes an anode electrode comprising a first current collector. Anode active material is arranged on a first surface of the first current collector and is configured to exchange lithium ions. The anode active material comprises silicon. Empty spaces are formed in the anode active material in a predetermined pattern. A solid electrolyte layer is arranged adjacent to the anode electrode. A cathode electrode comprises a second current collector and cathode active material configured to exchange lithium ions and arranged adjacent to the solid electrolyte layer.

### CROSS-REFERENCE TO RELATED APPLICATIONS

This application claims the benefit of Chinese Patent Application No. 202211400795.6, filed on Nov. 9, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to patterned silicon anode electrodes for all-solid-state batteries.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased power density and energy density to increase the performance of the EVs.

Lithium-ion battery (LIB) cells are currently used for high power density and high energy density applications. All-solid-state battery (ASSB) cells have improved characteristics compared to LIB cells in terms of abuse tolerance, and working temperature range.

### SUMMARY

A battery cell includes an anode electrode comprising a first current collector. Anode active material is arranged on a first surface of the first current collector and is configured to exchange lithium ions. The anode active material comprises silicon. Empty spaces are formed in the anode active material in a predetermined pattern. A solid electrolyte layer is arranged adjacent to the anode electrode. A cathode electrode comprises a second current collector and cathode active material configured to exchange lithium ions and arranged adjacent to the solid electrolyte layer.

In other features, the first surface of the first current collector is flat. The first surface of the first current collector is roughened. A highest point of the first current collector minus a lowest point of the first current collector is in a range from 0.1 μm to 20 μm. A highest point of the first current collector minus a lowest point of the first current collector is in a range from 0.1 μm to 12 μm.

In other features, the silicon of the anode active material includes silicon columns. The silicon columns have a semi-major axis in a range from 0.5 to 80 μm and the silicon columns have a semi-minor axis in a range from 0.5 to 80 μm.

In other features, the silicon columns have a semi-major axis in a range from 4 to 12 μm. The silicon columns have a semi-minor axis in a range from 4 to 12 μm. The silicon is selected from a group consisting of Si particles, Si wires, Si flakes, and porous Si.

In other features, the cathode electrode comprises cathode active material in a range from 30 to 98 wt %, solid electrolyte in a range from 0.1 to 50 wt %, a conductive additive in a range from 0.1 to 30 wt %, and a binder in a range from 0.1 to 20 wt %.

In other features, the solid electrolyte layer includes solid electrolyte selected from a group consisting of pseudobinary sulfide, pseudoternary sulfide, pseudoquaternary sulfide, a halide-based solid electrolyte, and a hydride-based solid electrolyte.

A method for manufacturing a battery cell comprises fabricating an anode electrode by providing a first current collector, arranging a mask defining a predetermined pattern on a first surface of the first current collector, and depositing anode active material onto the first surface of the first current collector. The anode active material is configured to exchange lithium ions and includes silicon. The method includes removing the mask and incorporating the anode electrode into the battery cell.

In other features, incorporating the anode electrode into the battery cell further comprises arranging a solid electrolyte layer adjacent to the anode electrode; and arranging a cathode electrode, comprising a second current collector and cathode active material configured to exchange lithium ions, adjacent to the solid electrolyte layer.

In other features, the method includes roughening the first surface of the first current collector, wherein a highest point of the first current collector minus a lowest point of the first current collector is in a range from 0.1 μm to 12 μm.

In other features, the silicon of the anode active material includes silicon columns, the silicon columns have a semi-major axis in a range from 0.5 to 80 μm, and the silicon columns have a semi-minor axis in a range from 0.5 to 80 μm.

In other features, the cathode electrode comprises the cathode active material in a range from 30 to 98 wt %, a first solid electrolyte in a range from 0.1 to 50 wt %, a conductive additive in a range from 0.1 to 30 wt %, and a binder in a range from 0.1 to 20 wt %, and the solid electrolyte layer includes solid electrolyte selected from a group consisting of pseudobinary sulfide, pseudoternary sulfide, pseudoquaternary sulfide, a halide-based solid electrolyte, and a hydride-based solid electrolyte.

A method for manufacturing a battery cell comprises fabricating an anode electrode by providing a first current collector; depositing anode active material onto a first surface of the first current collector, wherein the anode active material is configured to exchange lithium ions and includes silicon; and using a laser to selectively remove portions of the silicon to define a predetermined pattern on a first surface of the first current collector. The method includes incorporating the anode electrode into the battery cell.

In other features, incorporating the anode electrode into the battery cell further comprises arranging a solid electrolyte layer adjacent to the anode electrode; and arranging a cathode electrode, comprising a second current collector and cathode active material configured to exchange lithium ions, adjacent to the solid electrolyte layer.

In other features, the method includes roughening the first surface of the first current collector before the depositing, wherein a highest point of the first current collector minus a lowest point of the first current collector is in a range from 0.1 μm to 12 μm.

In other features, the silicon of the anode active material includes silicon columns, the silicon columns have a semi-major axis in a range from 0.5 to 80 μm, and the silicon columns have a semi-minor axis in a range from 0.5 to 80 μm.

In other features, the cathode electrode comprises the cathode active material in a range from 30 to 98 wt %, a first solid electrolyte in a range from 0.1 to 50 wt %, a conductive additive in a range from 0.1 to 30 wt %, and a binder in a range from 0.1 to 20 wt %, and the solid electrolyte layer includes solid electrolyte selected from a group consisting of pseudobinary sulfide, pseudoternary sulfide, pseudoquaternary sulfide, a halide-based solid electrolyte, and a hydride-based solid electrolyte.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell including a patterned silicon anode electrode according to the present disclosure;

FIG. 2 is a side cross-sectional view of an example of a patterned silicon anode electrode according to the present disclosure;

FIG. 3 is a plan view of an example of a patterned silicon anode electrode according to the present disclosure;

FIG. 4 is a perspective view of an example of a silicon column of the patterned silicon anode electrode according to the present disclosure;

FIGS. 5A to 5C are plan views of other examples of patterned silicon anode electrodes according to the present disclosure;

FIGS. 6A to 6D are side cross-sectional views illustrating using a laser to pattern of the silicon anode electrode according to the present disclosure;

FIGS. 7A to 7D are side cross-sectional views illustrating using masking to pattern the silicon anode electrode according to the present disclosure;

FIG. 8 is a graph showing capacity as a function of cycles for an example of the battery cell according to the present disclosure; and

FIG. 9 is a graph showing capacity retention as a function of cycles for an example of the battery cell according to the present disclosure.

In the drawings, reference numbers may be reused to identify similar and/or identical elements.

### DETAILED DESCRIPTION

While the battery cells according to the present disclosure are described below in the context of a vehicle, the battery cells according to the present disclosure can be used in other applications.

Silicon has emerged as an alternative material to graphite-based anode electrodes for all-solid-state battery cells in electric vehicles. Advantages of silicon include being environmental benign, reasonable electrochemical potential (˜0.3 V vs. Li/Li⁺), and a high theoretical capacity (4200 mAh/g for Li_{4.4}Si). However, Si anode electrodes experience large volumetric expansion (>300%) and high mechanical stress during charging. The stress causes cracking or pulverization of the silicon and rapid fading of capacity during cycling. The rate performance of solid-state Si anode electrodes is generally poor, which is likely due to unfavorable lithium-ion conduction.

An anode electrode for all-solid-state battery (ASSB) according to the present disclosure includes silicon columns arranged in a predetermined pattern with empty spaces there between. The empty spaces are created using laser patterning after deposition of the silicon columns or masking prior to deposition of the silicon columns. The empty spaces accommodate Si expansion during charging and help to release stress induced by Li-ion diffusion. As a result, the life of the ASSB is increased. The Si anode electrode also promotes Li-ion conduction between the columnar silicon and solid electrolyte to enhance the power capability of the ASSB.

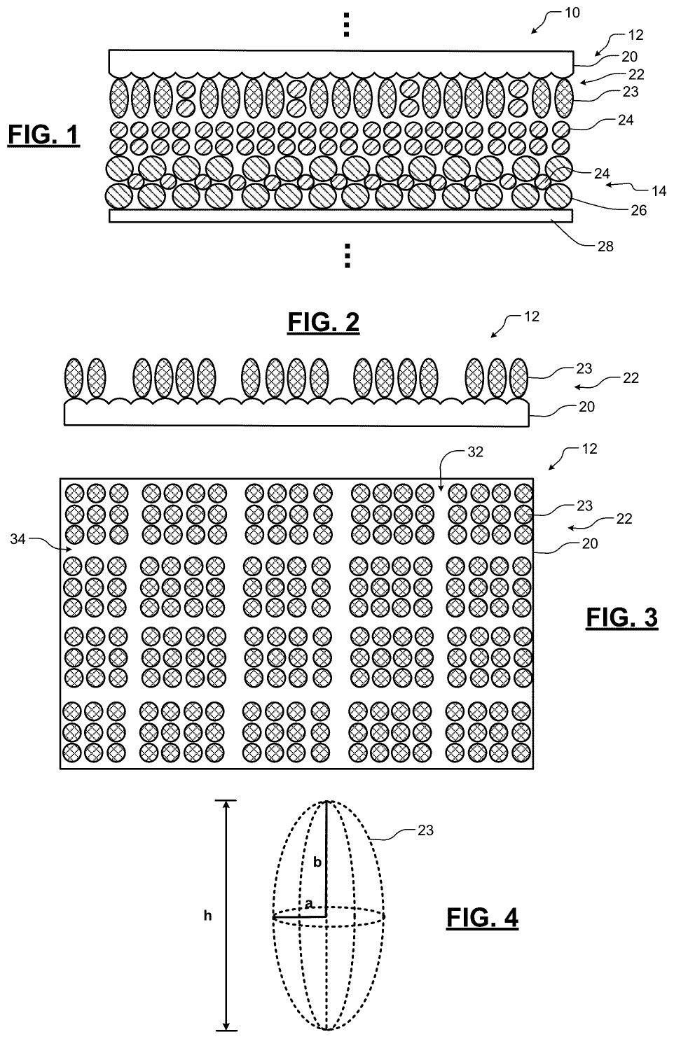

Referring now to FIGS. 1 to 3, an example of a battery cell 10 including a patterned silicon anode electrode 12 and a cathode electrode 14 is shown. In FIG. 1, the patterned silicon anode electrode 12 includes an anode current collector 20 and active anode material 22 including silicon arranged on the anode current collector 20. In some examples, the active anode material 22 includes silicon columns 23, although Si particles, Si wires, Si flakes, porous Si or other Si format can be used. As will be described further below, the active anode material 22 is patterned after deposition using laser patterning or before deposition using masking to create empty spaces.

Solid electrolyte 24 is arranged between the patterned silicon anode electrode 12 and the cathode electrode 14. Solid electrolyte 24 may also be located in the empty spaces between the silicon columns 23 of the active anode material 22. The cathode electrode 14 includes cathode active material 26 arranged on a cathode current collector 28. Solid electrolyte 24 may also be located between the cathode active material 26.

In FIG. 2, the patterned silicon anode electrode 12 includes the anode current collector 20. In some examples, the anode current collector 20 is flat or one or both surfaces of the anode current collector 20 are one of flat or roughened. In some examples, the anode current collector 20 is roughened and a highest point of the anode current collector 20 minus a lowest point of the current collector) is in a range from 0.1 μm to 20 μm. In some examples, a highest point of the anode current collector 20 minus a lowest point of the current collector) is in a range from 0.1 μm to 12 μm. The empty spaces between the silicon columns 23 accommodate Si expansion during charging. The empty spaces release mechanical stress and minimize structural damage of the Si film. This in turn, improves electrochemical reversibility and prolongs the cycle life of ASSB. The empty spaces between the silicon columns provide more sites for solid electrolyte to be located, which increases the Li-ion conduction paths between silicon and solid electrolyte and enhances power capability.

If used, the roughened surface strengthens adhesion between the anode current collector 20 and the Si columns. In some examples, the anode current collector 20 has a thickness in a range from 4 to 30 μm (e.g., 14 μm). In some examples, the anode current collector 20 is made of a material selected from a group consisting of copper (Cu), stainless steel, nickel, iron, titanium, conductive alloys, and other conductive materials. In other examples, the anode current collector 20 includes foil such as stainless steel foil that is coated with graphene or carbon.

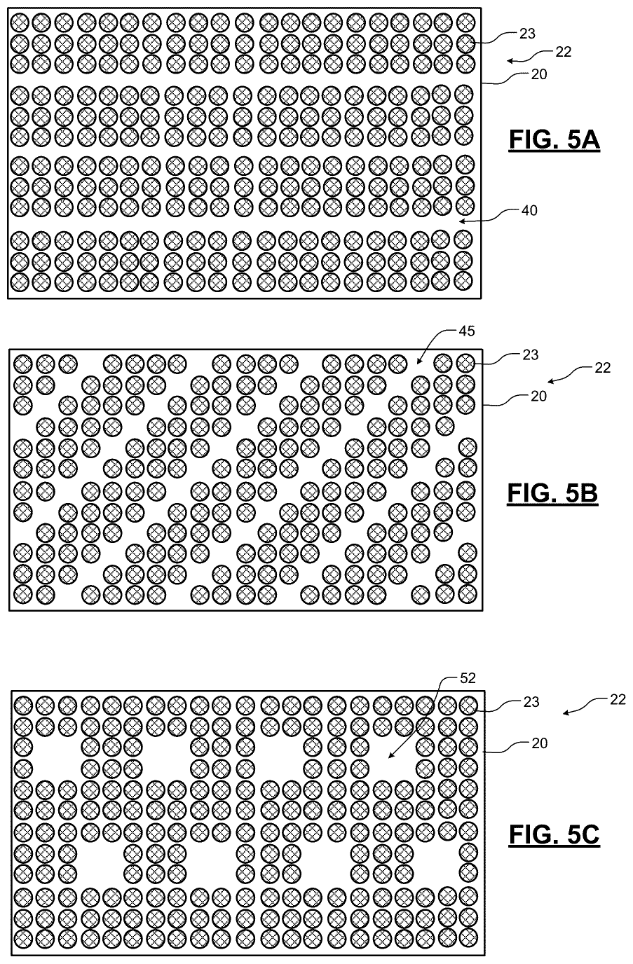

The silicon columns 23 are patterned using a laser or a mask. In other words, the silicon columns 23 are arranged in some locations and are not located in other locations of the anode current collector 20. In FIG. 3, the silicon columns 23 of the patterned silicon anode electrode 12 are arranged in a checkered pattern with vertical and/or horizontal empty spaces 32 and 34, respectively. While a specific pattern is shown in FIG. 3, other patterns may be used (additional examples are shown in FIGS. 5A to 5C).

Referring now to FIG. 4, an example a shape of the silicon columns 23 is shown. In some examples, the silicon columns 23 are ellipsoidal. In some examples, the silicon columns 23 have an elliptical cross-sectional shape with dimensions a and b. Dimension b corresponds to a semi-major axis and dimension a corresponds to a semi-minor axis. In some examples, a is in a range from 0.5 to 80 μm (e.g., 8 μm). In some examples, b is in a range from 0.5 to 80 μm (e.g., 8 μm). In some examples, the silicon columns are fabricated using physical vapor deposition (PVD). In some examples, the silicon columns 23 are spaced from an adjacent silicon column 23 in a range from 10 nm to 400 μm (e.g., 40 nm to 60 nm).

In some examples, the active anode material 22 includes silicon columns 23, although Si particles, Si wires, Si flakes, porous Si or other Si material can be used. In some examples, the active anode material 22 may further include graphite to enhance battery cyclability. In some examples, the graphite has a particle size in the range from 50 nm to 20 μm.

Referring now to FIGS. 5A to 5C, examples of other patterns of the silicon columns that can be used are shown. In FIG. 5A, empty spaces 40 include empty horizontal rows (or vertical rows (not shown)) located between one or more rows of silicon columns 23. In FIG. 5B, the empty spaces 45 include diagonal empty spaces in one or more directions. In FIG. 5C, empty spaces 52 have a predetermined shape such as rectangular, round, triangular, elliptical, etc. In some examples, the empty spaces have a regular or irregular shape and are arranged in symmetric or asymmetric patterns.

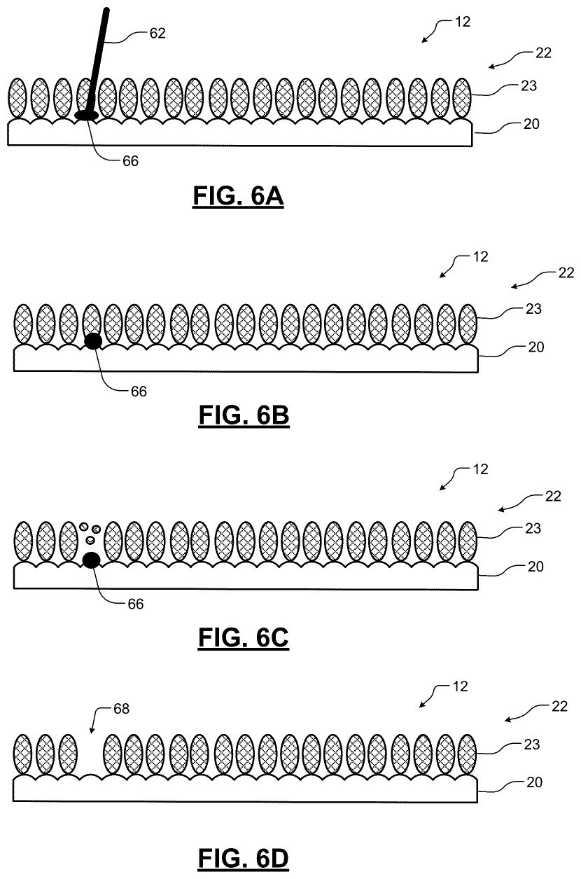

Referring now to FIGS. 6A to 6D, the silicon columns 23 of the patterned silicon anode electrode 12 can be patterned after deposition using a laser. The silicon columns 23 of the anode current collector 20 are initially formed and then removed using the laser. In FIG. 6A, a laser 60 generates a laser beam 62 that heats one or more of the silicon columns 23. Energy from the laser beam 62 is absorbed by the anode current collector (e.g., at 66). In FIG. 6B, plasma is generated at an interface between the silicon column 23 and the anode current collector 20. In FIG. 6C, plasma pressure induces cracks and the silicon column 23 breaks into smaller particles. In FIG. 6D, the silicon column 23 is removed and an empty space 68 is created. The process is repeated for other locations to create the desired pattern.

Mechanical removal of the silicon columns 23 occurs when plasma pressure is greater than a predetermined pressure. In some examples, the laser operates at a predetermined frequency. In some examples, the predetermined frequency is 1064 nm.

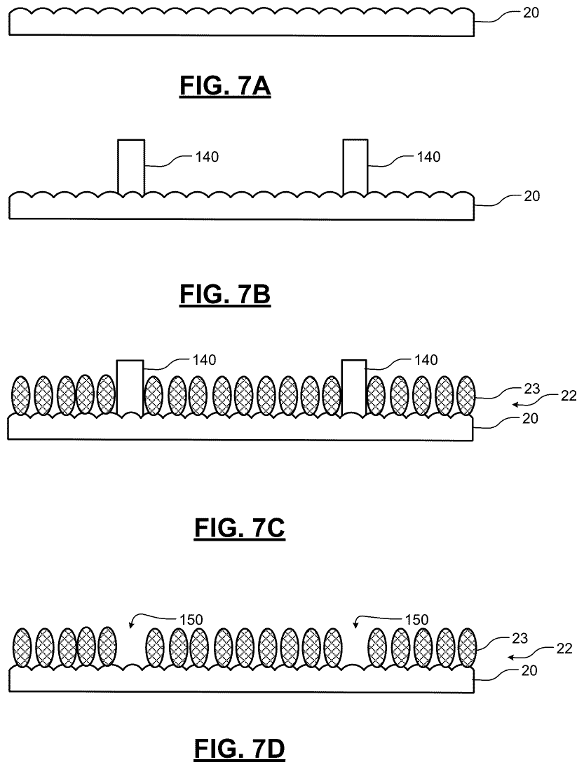

Referring now to FIGS. 7A to 7D, the silicon columns 23 of the patterned silicon anode electrode 12 can be patterned before deposition using masking. In FIG. 7A, the anode current collector 20 is shown prior to depositing the silicon columns 23. In FIG. 7B, a mask 140 defining the desired pattern of the empty spaces is formed on or arranged adjacent to the anode current collector 20. In FIG. 7C, the silicon columns 23 are deposited in areas where the mask 140 is not located. In FIG. 7D, the mask 140 is removed to reveal empty spaces 150.

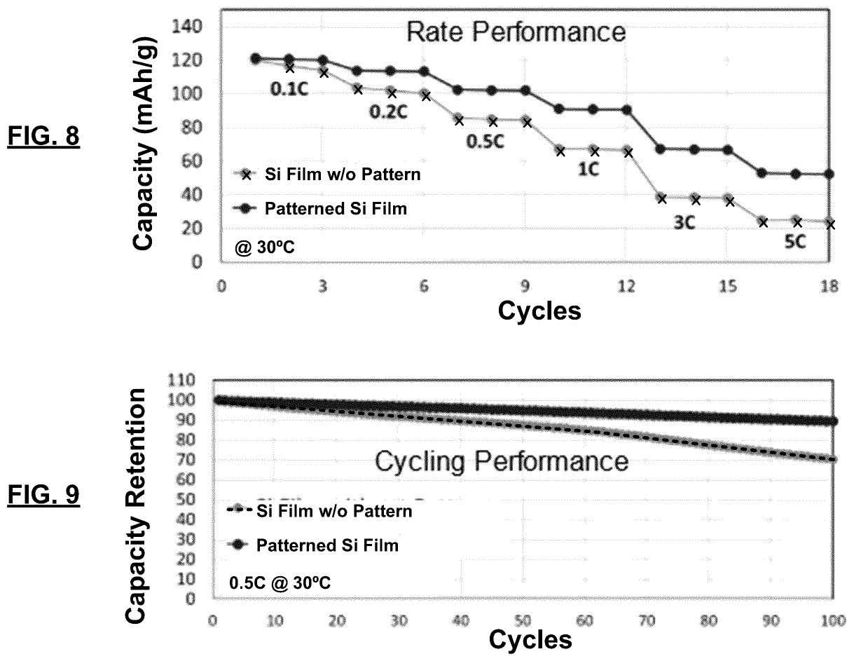

Referring now to FIGS. 8 and 9, battery cells with the patterned silicon anode electrode 12 have improved performance. In FIG. 8, capacity as a function of cycles of battery cells including the patterned silicon anode electrode 12 is greater than battery cells including the silicon anode electrodes without patterning. In FIG. 9, capacity retention as a function of cycles of battery cells including the patterned silicon anode electrode 12 is greater than battery cells including the silicon anode electrodes without patterning.

In some examples, the solid electrolyte is selected from a group consisting of pseudobinary sulfide, pseudoternary sulfide, pseudoquaternary sulfide, a halide solid electrolyte, and a hydride solid electrolyte. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system.

Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4LiI·0.6Li₄SnS₄ and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of halide-based solid electrolyte includes Li₃YCl₆, Li₃InCl₆, Li₃YBr₆, LiI, Li₂CdCl₄, Li₂MgCl₄, Li₂CdI₄, Li₂ZnI₄, Li₃OCl. Examples of hydride-based solid electrolyte include LiBH₄, LiBH₄—LiX (X=Cl, Br, or I), LiNH₂, Li₂NH, LiBH₄—LiNH₂, Li₃AlH₆. In other examples, other solid electrolyte with low grain-boundary resistance can be used.

In some examples, the cathode electrode has a thickness in a range from 10 to 500 μm (e.g., 40 μm). In some examples, the cathode electrode includes cathode active material in a range from 30 to 98 wt %, solid electrolyte in a range from 0.1 to 50 wt %, conductive additive in a range from 0.1 to 30 wt %, and binder in a range from 0.1 to 20 wt %.

In some examples, the cathode active material is selected from a group consisting of rock salt layered oxides, spinel, polyanion cathode materials, and surface-coated and/or doped cathode materials. Examples of rock salt layered oxides include LiCoO₂, LiNiₓMn_{y}Co_{1-x-y}O₂, LiNiₓMn_{y}Al_{1-x-y}O₂, LiNiₓMn₁₋ₓO₂, and Li₁₊ₓMO₂. Examples of spinel include LiMn₂O₄, LiNi_{0.5}Mn_{1.5}O₄. Examples of polyanion cathode materials include LiV₂(PO₄)₃. In other examples, the cathode active material includes other lithium transition-metal oxides. Examples of surface-coated cathode materials include LiNbO₃-coated LiMn₂O₄ and Li₂ZrO₃ or Li₃PO₄-coated LiNiₓMn_{y}Co_{1-x-y}O₂. Examples of doped cathode materials include Al-doped LiMn₂O₄. In other examples, a low voltage cathode material such as lithiated metal oxide/sulfide (e.g., LiTiS₂), lithium sulfide, or sulfur can be used.

In some examples, the conductive additive is selected from a group consisting of carbon black, graphite, graphene, graphene oxide, Super P, acetylene black, carbon nanofibers, carbon nanotubes and other electronically conductive additives.

In some examples, the binder includes a material selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
an anode electrode comprising:
a first current collector;
anode active material arranged on a first surface of the first current collector and configured to exchange lithium ions, wherein the anode active material comprises silicon;
empty spaces formed in the anode active material in a predetermined pattern;
a solid electrolyte layer arranged adjacent to the anode electrode; and
a cathode electrode comprising:
a second current collector; and
cathode active material configured to exchange lithium ions and arranged adjacent to the solid electrolyte layer.

2. The battery cell of claim 1, wherein the first surface of the first current collector is flat.

3. The battery cell of claim 1, wherein:
the first surface of the first current collector is roughened, and
a highest point of the first current collector minus a lowest point of the first current collector is in a range from 0.1 μm to 20 μm.

4. The battery cell of claim 2, wherein a highest point of the first current collector minus a lowest point of the first current collector is in a range from 0.1 μm to 12 μm.

5. The battery cell of claim 1, wherein the silicon of the anode active material includes silicon columns.

6. The battery cell of claim 5, wherein:
the silicon columns have a semi-major axis in a range from 0.5 to 80 μm and
the silicon columns have a semi-minor axis in a range from 0.5 to 80 μm.

7. The battery cell of claim 5, wherein:
the silicon columns have a semi-major axis in a range from 4 to 12 μm and
the silicon columns have a semi-minor axis in a range from 4 to 12 μm.

8. The battery cell of claim 1, wherein the silicon is selected from a group consisting of Si particles, Si wires, Si flakes, and porous Si.

9. The battery cell of claim 1, wherein the cathode electrode comprises cathode active material in a range from 30 to 98 wt %, solid electrolyte in a range from 0.1 to 50 wt %, a conductive additive in a range from 0.1 to 30 wt %, and a binder in a range from 0.1 to 20 wt %.

10. The battery cell of claim 1, wherein the solid electrolyte layer includes solid electrolyte selected from a group consisting of pseudobinary sulfide, pseudoternary sulfide, pseudoquaternary sulfide, a halide-based solid electrolyte, and a hydride-based solid electrolyte.

11. A method for manufacturing a battery cell comprising:
fabricating an anode electrode by:
providing a first current collector;
arranging a mask defining a predetermined pattern on a first surface of the first current collector;
depositing anode active material onto the first surface of the first current collector, wherein the anode active material is configured to exchange lithium ions and includes silicon; and
removing the mask; and
incorporating the anode electrode into the battery cell.

12. The method of claim 11, wherein incorporating the anode electrode into the battery cell further comprises:
arranging a solid electrolyte layer adjacent to the anode electrode; and
arranging a cathode electrode, comprising a second current collector and cathode active material configured to exchange lithium ions, adjacent to the solid electrolyte layer.

13. The method of claim 11, further comprising roughening the first surface of the first current collector, wherein a highest point of the first current collector minus a lowest point of the first current collector is in a range from 0.1 μm to 12 μm.

14. The method of claim 11, wherein:
the silicon of the anode active material includes silicon columns,
the silicon columns have a semi-major axis in a range from 0.5 to 80 μm, and
the silicon columns have a semi-minor axis in a range from 0.5 to 80 μm.

15. The method of claim 12, wherein:
the cathode electrode comprises the cathode active material in a range from 30 to 98 wt %, a first solid electrolyte in a range from 0.1 to 50 wt %, a conductive additive in a range from 0.1 to 30 wt %, and a binder in a range from 0.1 to 20 wt %, and
the solid electrolyte layer includes solid electrolyte selected from a group consisting of pseudobinary sulfide, pseudoternary sulfide, pseudoquaternary sulfide, a halide-based solid electrolyte, and a hydride-based solid electrolyte.

16. A method for manufacturing a battery cell comprising:
fabricating an anode electrode by:
providing a first current collector;
depositing anode active material onto a first surface of the first current collector, wherein the anode active material is configured to exchange lithium ions and includes silicon; and
using a laser to selectively remove portions of the silicon to define a predetermined pattern on a first surface of the first current collector; and
incorporating the anode electrode into the battery cell.

17. The method of claim 16, wherein incorporating the anode electrode into the battery cell further comprises:
arranging a solid electrolyte layer adjacent to the anode electrode; and
arranging a cathode electrode, comprising a second current collector and cathode active material configured to exchange lithium ions, adjacent to the solid electrolyte layer.

18. The method of claim 16, further comprising roughening the first surface of the first current collector before the depositing, wherein a highest point of the first current collector minus a lowest point of the first current collector is in a range from 0.1 μm to 12 μm.

19. The method of claim 16, wherein:
the silicon of the anode active material includes silicon columns,
the silicon columns have a semi-major axis in a range from 0.5 to 80 μm, and
the silicon columns have a semi-minor axis in a range from 0.5 to 80 μm.

20. The method of claim 17, wherein:
the cathode electrode comprises the cathode active material in a range from 30 to 98 wt %, a first solid electrolyte in a range from 0.1 to 50 wt %, a conductive additive in a range from 0.1 to 30 wt %, and a binder in a range from 0.1 to 20 wt %, and
the solid electrolyte layer includes solid electrolyte selected from a group consisting of pseudobinary sulfide, pseudoternary sulfide, pseudoquaternary sulfide, a halide-based solid electrolyte, and a hydride-based solid electrolyte.
